(19) United States
(12) Patent Application Publication
(10) Pub. No.: US 2025/0096622 A1
(43) Pub. Date: Mar. 20, 2025

(54) ROTATING ELECTRIC MACHINE

(71) Applicant: KABUSHIKI KAISHA TOSHIBA, Tokyo (JP)

(72) Inventors: Masaya HAGIWARA, Yokohama Kanagawa (JP); Kei MATSUOKA, Kawasaki Kanagawa (JP); Hiroaki KINOUCHI, Meguro Tokyo (JP); Shinya SAKURADA, Saitama Saitama (JP)

(73) Assignee: KABUSHIKI KAISHA TOSHIBA, Tokyo (JP)

(21) Appl. No.: 18/764,233

(22) Filed: Jul. 4, 2024

(30) Foreign Application Priority Data
Sep. 20, 2023 (JP) 2023-154012

(51) Int. Cl. H02K 1/14; H02K 9/22

(52) U.S. Cl. CPC H02K 1/148; H02K 9/223

(57) ABSTRACT

A rotating electric machine of an embodiment includes a stator, a rotor, a housing, and a cover member. The stator includes a stator core and a coil. The stator core includes a core back portion. The core back portion has an annular shape centered on a center axis. The coil is attached to the stator core. The coil is located on the radially inside of the core back portion. The coil includes a coil straight portion and a pair of coil end portions. The coil straight portion extends in a straight line shape along the axial direction. The pair of coil end portions respectively protrude in the axial direction from both axial end surfaces of the stator core. The cover member includes a first cover portion. The first cover portion contacts one coil end portion so that the coil end portion is bent toward an inner peripheral surface of the housing and is brought into contact with the inner peripheral surface of the housing.

### BACKGROUND

### Field

Embodiments described herein relate generally to a rotating electric machine.

### Related Art

With the recent increasing awareness of environmental considerations, an aircraft having a propulsion fan driven by a rotating electric machine is being developed. The rotating electric machine for aircraft is required to be lightweight. Therefore, it is preferable to adopt an air cooling type as a cooling mechanism of the rotating electric machine for aircraft. Then, in this case, it is required to efficiently transfer the heat of a coil to a stator core.

### PATENT DOCUMENTS

[Patent Document 1] Japanese Unexamined Patent Application, First Publication No. 2017-153230

### BRIEF DESCRIPTION OF THE DRAWINGS

FIG. 1 is a cross-sectional view taken along a center axis of a rotating electric machine according to an embodiment.

FIG. 2 is a cross-sectional view orthogonal to the center axis of the rotating electric machine according to the embodiment.

FIG. 3 is a schematic cross-sectional view of a stator of the rotating electric machine according to the embodiment.

FIG. 4 is an enlarged view of a region IV of FIG. 3.

FIG. 5 is a perspective view schematically showing a filler provided in the rotating electric machine according to the embodiment.

FIG. 6 is a flowchart of a method of manufacturing the stator of the rotating electric machine according to the embodiment.

FIG. 7 is a schematic view showing a jig removal step of the method of manufacturing the stator of the rotating electric machine according to the embodiment.

FIG. 8 is a schematic view showing a resin addition step of the method of manufacturing the stator of the rotating electric machine according to the embodiment.

FIG. 9 is a schematic view showing a resin portion of a first modified example.

FIG. 10 is a schematic view showing a resin portion of a second modified example.

FIG. 11 is a schematic view showing a configuration example of an aircraft.

### DETAILED DESCRIPTION OF THE INVENTION

Hereinafter, a rotating electric machine of an embodiment will be described with reference to the drawings.

The design of the rotating electric machine can be changed as appropriate to suit specifications and the like. Therefore, the shape and the like of each member included in the rotating electric machine can be changed arbitrarily, and the shape, number, and the like in the drawings are merely examples.

A rotating electric machine is configured to efficiently transfer the heat of a coil to a stator core.

A rotating electric machine of an embodiment includes a stator and a rotor. The stator has an annular shape centered on a center axis. The rotor is located on one radial side of the stator. The rotor is supported to be rotatable around the center axis. The stator includes a stator core, a coil of a bundle of coil wires, and a resin portion. The stator core includes a core back portion having an annular shape centered on the center axis. The coil is disposed on one radial side of the core back portion. The resin portion fixes the coil to the stator core. The resin portion includes a first region and a second region. The first region extends in a radial direction along a coil side surface facing a circumferential direction of the coil. The second region extends in the circumferential direction along a support surface facing the one radial side of the core back portion. The resin portion includes fillers. The first region has a first thermal conductivity in the radial direction and a second thermal conductivity in the circumferential direction. The first thermal conductivity is greater than the second thermal conductivity. The second region has a third thermal conductivity in the circumferential direction and a fourth thermal conductivity in the radial direction, and the third thermal conductivity is greater than the fourth thermal conductivity.

A rotating electric machine of an embodiment includes a stator and a rotor. The stator has an annular shape centered on a center axis. The rotor is located on one radial side of the stator. The rotor is supported to be rotatable around the center axis. The stator includes a stator core, a coil of a bundle of coil wires, and a resin portion. The stator core includes a core back portion having an annular shape centered on the center axis. The coil is disposed on one radial side of the core back portion. The resin portion fixes the coil to the stator core. The resin portion includes a first region and a second region. The first region extends in the radial direction along a coil side surface facing the circumferential direction of the coil. The second region extends in the circumferential direction along a support surface facing the one radial side of the core back portion. The resin portion includes fillers. Each filler has a respective longitudinal direction having a first orientation angle which is defined to be a first inclination angle inclined with respect to the coil side surface in view of an axial direction of the center axis. The fillers in the first region includes a first group of fillers which are smaller in the first orientation angles than 45°, and a second group of fillers which are equal or greater in the first orientation angles than 45°. The number of the first group of fillers is greater than the number of the second group of fillers.

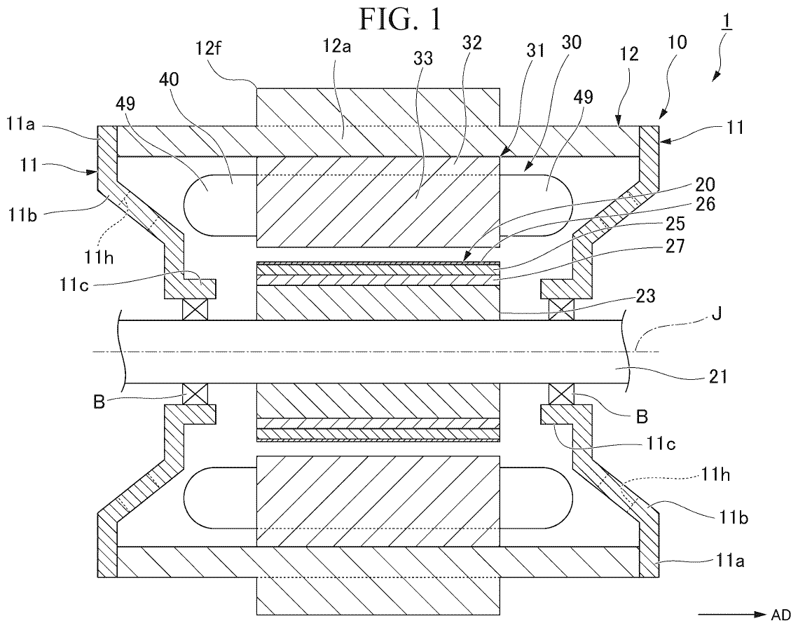

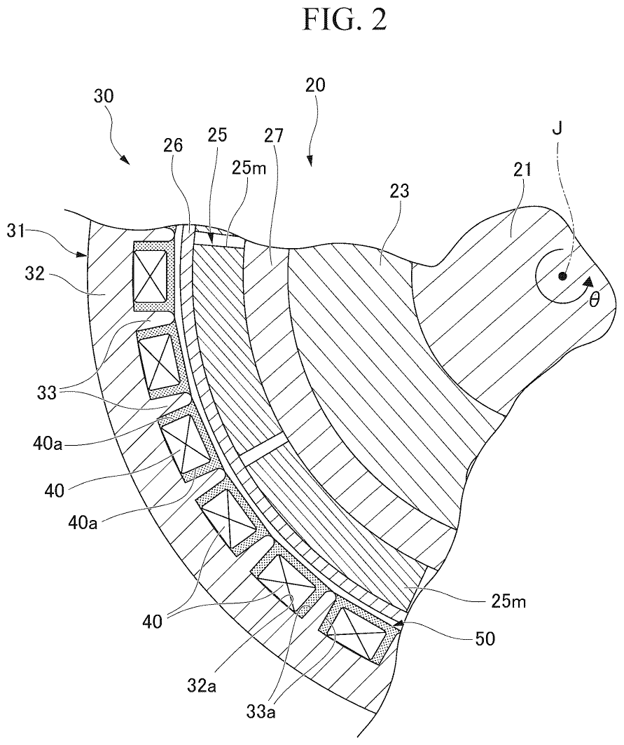

FIG. 1 is a cross-sectional view taken along a center axis J of a rotating electric machine 1 of this embodiment. FIG. 2 is a cross-sectional view orthogonal to the center axis J of the rotating electric machine 1 of this embodiment.

In the following description, the direction parallel to a center axis J is simply referred to as the “axial direction”, the radial direction centered on the center axis J is simply referred to as the “radial direction”, and the circumferential direction centered on the center axis J is simply referred to as the “circumferential direction θ”. Additionally, in each figure, the axial direction AD, the radial direction RD, and the circumferential direction θ are illustrated as necessary. In each figure, the direction in which the arrow of the axial direction AD points is referred to as “one axial side (+AD)” and the opposite direction is referred to as the “other axial side (−AD).” Further, the direction in which the arrow of the radial direction RD points is referred to as the “radially inside” or “one radial side (+RD)” and the opposite direction is referred to as the “radially outside” or the “other radial side (−RD)”.

As shown in FIG. 1, the rotating electric machine 1 includes, for example, a stator 30 which has an annular shape centered on the center axis J, a rotor 20 which is located on the radially inside of the stator 30, and a tubular housing 10 which accommodates the stator 30 and the rotor 20.

The rotating electric machine 1 of this embodiment is an inner rotor type rotating electric machine in which the rotor 20 is located on the radially inside of the stator 30. However, the rotating electric machine may be of an outer rotor type in which the rotor is disposed on the radially outside of the stator. In this case, each part of the rotor has a configuration in which one side and the other side in the radial direction are reversed.

The housing 10 includes a housing body 12 which extends in the axial direction and surrounds the stator 30 from the radially outside and a bearing holder 11 which is fixed to each of one axial end and the other axial end of the housing body 12.

The housing body 12 includes, for example, a cylindrical portion 12a which has a cylindrical shape centered on the center axis J and a plurality of radiation fins 12f which protrude radially outward from the outer peripheral surface of the cylindrical portion 12a. The cylindrical portion 12a is in contact with a stator core 31 of the stator in the inner peripheral surface facing the radially inside. The heat of the stator 30 is transferred to the cylindrical portion 12a and is transferred from the cylindrical portion 12a to the radiation fin 12f. For example, the plurality of radiation fins 12f are arranged without a slight gap therebetween in the circumferential direction. The gaps between the radiation fins 12f are opened on both sides in the axial direction. The rotating electric machine 1 is mounted on an aircraft 90, for example, in a posture in which the center axis J is parallel to the traveling direction of the aircraft 90. As the aircraft 90 flies, air passes through the gaps between the radiation fins 12f to cool the housing 10.

The bearing holder 11 has a disc shape centered on the center axis J. The pair of bearing holders 11 respectively cover the openings of the cylindrical portion 12a on both sides in the axial direction. The bearing holder 11 includes a fixed portion 11a, a tapered portion 11b, and a bearing holding portion 11c. The fixed portion 11a has an annular plate shape centered on the center axis J. The fixed portion 11a is fixed to an end surface of the cylindrical portion 12a facing the axial direction by a bolt (not shown).

The tapered portion 11b has, for example, a conical shape. The tapered portion 11b extends radially inward from the fixed portion 11a to be inclined toward the stator 30 in the axial direction AD. The tapered portion 11b is provided with, for example, a plurality of introduction holes 11h. The introduction hole 11h penetrates the tapered portion 11b in the axial direction AD. The plurality of introduction holes 11h allow the inner and outer spaces of the housing 10 to communicate with each other. For example, the air in the outer space is introduced into the inner space of the housing 10 through the introduction hole 11h of one bearing holder 11 to cool the rotor 20 and the stator 30. Further, the air warmed by the rotor 20 and the stator 30 is guided to the outside of the housing 10 through the introduction hole 11h of the other bearing holder 11. Furthermore, the tapered portion 11b does not have to be provided necessarily and the fixed portion 11a and the bearing holding portion 11c may be connected in a plane.

The bearing holding portion 11c has, for example, a cylindrical shape centered on the center axis J. A bearing B is held on the inner peripheral surface of the bearing holding portion 11c. The bearing B rotatably supports a shaft 21 of the rotor 20.

The rotor 20 is supported by the housing 10 to be rotatable around the center axis J. The rotor 20 includes the shaft 21 having the center axis J, a hub member 23, a rotor core 27, a magnet unit 25, and a cover 26.

The shaft 21 has, for example, a columnar shape extending in the axial direction about the center axis J. The hub member 23 has, for example, a tubular shape having a sufficient thickness in the radial direction. The hub member 23 is fixed to the outer peripheral surface of the shaft 21. Further, the rotor core 27 is fixed to the outer peripheral surface of the hub member 23. Furthermore, the hub member 23 may be provided with a plurality of through-holes 23h penetrating in the axial direction.

The rotor core 27 is made of a magnetic material. The rotor core 27 is, for example, a laminated steel plate formed by laminating a plurality of electromagnetic steel plates in the axial direction. The rotor core 27 of the rotating electric machine 1 according to this embodiment has a cylindrical shape. The magnet unit 25 is disposed on the outer peripheral surface of the rotor core 27.

As shown in FIG. 2, the magnet unit 25 has, for example, an annular shape. The magnet unit 25 can be fixed to, for example, the outer peripheral surface of the rotor core 27 by bonding means such as an adhesive. The rotor 20 of the rotating electric machine 1 according to this embodiment is of a surface magnet type in which the magnet unit 25 magnetically directly faces the stator 30. The configuration of the rotor 20 is not limited to this embodiment and the rotor may be, for example, of an embedded magnet type.

The magnet unit 25 includes a magnet 25m with an S pole facing radially outward and a magnet 25m with an N pole facing radially outward and has a configuration in which these magnets are arranged alternately in the circumferential direction. That is, the magnet unit 25 includes the plurality of magnets 25m whose magnetization directions alternate in the circumferential direction. The magnet unit 25 is adhesively fixed to the outer surface of the rotor core 27. Further, the magnet unit 25 is covered by, for example, the tubular cover 26. The cover 26 is made of a material that does not easily affect the magnetic force of the magnet unit 25.

As shown in FIG. 1, the stator 30 surrounds the rotor 20 from the radially outside. As shown in FIG. 2, the stator 30 includes, for example, the stator core 31, a coil 40, a resin portion 50, and an insulating member (not shown).

The stator core 31 is, for example, a laminated steel plate formed by laminating a plurality of electromagnetic steel plates in the axial direction. As shown in FIG. 1, the outer peripheral surface of the stator core 31 contacts the inner peripheral surface of the cylindrical portion 12a of the housing 10. The heat of the stator 30 is transferred from the outer peripheral surface of the stator core 31 to the housing 10 and is radiated in the radiation fin 12f.

As shown in FIG. 2, the stator core 31 includes, for example, a core back portion 32 and a plurality of protrusion portions 33. The stator core 31 is made of a magnetic material.

The core back portion 32 has, for example, an annular shape centered on the center axis J. The core back portion 32 has a support surface 32a facing radially outward. The coil 40 is disposed on the radially inside of the core back portion 32. The support surface 32a supports the coil 40 from the radially outside with an insulating member (not shown) interposed therebetween. This insulating member may be, for example, an insulating paper. The insulating member may be made of any one of resin, adhesive, glass cloth, insulating paper, and Kapton tape, or any other material as long as it is an insulating member. Furthermore, this insulating member may be a part of the resin portion 50 to be described later.

The plurality of protrusion portions 33 protrude radially inward from the support surface 32a of the core back portion 32. The protrusion portion 33 has, for example, a rib shape extending in the axial direction. The plurality of protrusion portions 33 are arranged in the circumferential direction. The coil 40 is disposed between the protrusion portions 33 adjacent to each other in the circumferential direction. That is, the protrusion portion 33 faces the coil 40 in the circumferential direction. Further, the protrusion portion 33 includes a pair of protrusion side surfaces 33a. One of the pair of protrusion side surfaces 33a faces one circumferential side and the other faces the other circumferential side.

The coil 40 is disposed between the protrusion portions 33 arranged in the circumferential direction on the radially inside of the core back portion 32. The plurality of coils 40 are classified as multi-phase coils. Alternating currents with different phases flow through the coils 40 with different phases. For example, the coils of the rotating electric machine 1 according to this embodiment include three phase coils 40, and alternating currents with phases shifted by 120° are passed through these coils 40. Here, in order to illustrate and describe a three-phase AC rotating electric machine, the plurality of coils 40 are classified into three phases, but the number of phases is not limited to this embodiment. Further, the phase difference between the alternating currents flowing through the coils 40 of each phase is changed as appropriate depending on the number of phases. The coil 40 of the rotating electric machine 1 according to this embodiment is configured, for example, by distributed winding in which coils 40 of different phases overlap in the radial direction while being offset in the circumferential direction.

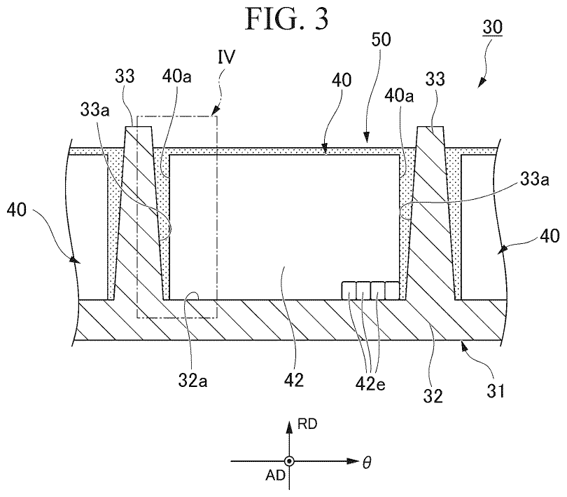

FIG. 3 is a schematic cross-sectional view of the stator 30 of the rotating electric machine 1 according to this embodiment. Furthermore, in FIG. 3, the circumferential direction is represented as a straight line.

As shown in FIG. 3, the coil 40 includes a plurality of wires bundles 42. In the stator 30 of the rotating electric machine 1 according to this embodiment, the plurality of wires bundles 42 are arranged in the region between the pair of protrusion portions 33. Further, each wire bundle 42 is configured by bundling a plurality of coils wires 42e. The coil wire 42e may be a round wire or a square wire, or may have a different cross-sectional shape. The wire bundle 42 constitutes the coil 40 by being wound in a loop shape multiple times between the protrusions 33. Furthermore, a part of the wire bundle 42 protrudes toward one axial side and the other axial side of the stator core 31 to constitute a coil end 49 (see FIG. 1). The number of the wire bundles 42 arranged in the region between the protrusion portions 33 can be changed arbitrarily depending on the coil design.

The coil 40 has a coil side surface 40a. The coil side surface 40a is a surface that faces the circumferential direction of the coil. As described above, since the coil 40 is configured by bundling the plurality of coil wires 42e, the coil side surface 40a is configured by connecting the side surfaces of the plurality of coil wires 42e.

Furthermore, in this embodiment, for example, insulating paper (not shown) is wrapped around the outer periphery of the coil 40 to ensure insulation between the coil and the stator core 31. The insulating paper or the like may be provided between the coil 40 and the stator core 31 and may be disposed to cover a protrusion side surface 33a and the support surface 32a of the stator core 31.

The resin portion 50 is provided to fix the coil 40 to the stator core 31. The resin portion 50 is located on the radially inside of the core back portion 32, is filled in an uncured state between the protrusion portions 33 arranged in the circumferential direction, and is cured after the coil 40 is disposed.

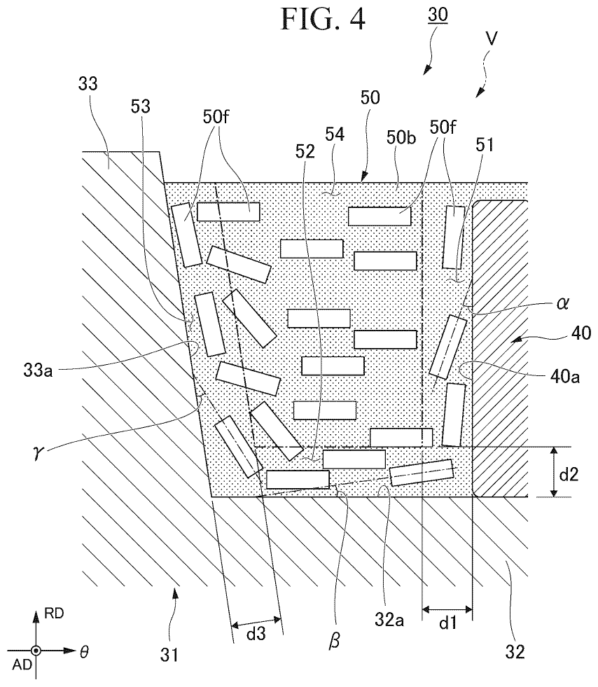

FIG. 4 is an enlarged view of a region IV of FIG. 3. The resin portion 50 includes an adhesive 50b as a binder and a plurality of fillers 50f. As the adhesive 50b, epoxy resin, polyester resin, amide resin, imide resin, insulating varnish, and the like can be used. The plurality of fillers 50f are arranged to be diffused inside the adhesive 50b. Some of the plurality of fillers 50f may be in contact with each other.

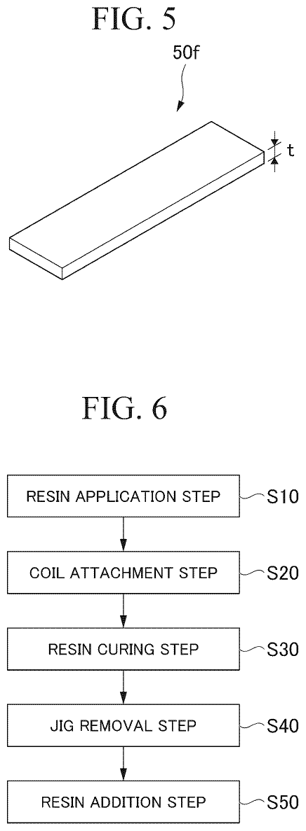

FIG. 5 is a schematic view of the filler 50f of the rotating electric machine 1 according to this embodiment. The filler 50f has, for example, a plate shape having a substantially constant thickness. The thickness t of the filler 50f is, for example, 0.1 μm or more and 200 μm or less. Further, the content of the filler 50f in the resin portion 50 can be 10% by weight or more and 90% by weight or less. By blending the filler 50f with the above-described thickness t at a content within the above-described range, it is possible to increase the thermal conductivity of the resin portion 50 while ensuring the retention strength of the coil 40 by the resin portion 50. Furthermore, irregularities may be formed on the surface of the plate-shaped filler 50f. Therefore, the thickness t of the plate-shaped filler 50f is determined by dividing the filler 50f into 10 equal parts in the longitudinal direction of the filler 50f, measuring the thickness at each point, and averaging these.

As the filler 50f of the rotating electric machine 1 according to this embodiment, ceramics such as aluminum nitride (AlN), silicon nitride (Si₃N₄), boron nitride (BN), alumina (Al₂O₃), silica (SiO₂), magnesia (MgO), silicon carbide (SiC), or metal nanofibers can be used. Furthermore, in this embodiment, a case will be described in which the plate-shaped filler 50f is adopted, but the filler 50f is not limited to this embodiment as long as it has a shape that can define the longitudinal direction. The filler 50f may have an amorphous shape, or may have an acicular shape or an ellipsoidal shape.

As shown in FIG. 4, the resin portion 50 of the rotating electric machine 1 according to this embodiment includes a first region 51, a second region 52, a third region 53, and a fourth region 54. The first region 51, the second region 52, the third region 53, and the fourth region 54 are regions inside the spaces surrounded by the support surface 32a of the core back portion 32, the protrusion side surface 33a of the protrusion portion 33, and the coil side surface 40a of the coil 40. The first region 51 is a region extending in the radial direction along the coil side surface 40a. The second region 52 is a region extending in the circumferential direction along the support surface 32a. The third region 53 is a region extending in the radial direction along the protrusion side surface 33a. The fourth region 54 is a region surrounded by the first region 51, the second region 52, and the third region 53. Furthermore, the end of the first region 51 on the radially outside (−RD) overlaps the end of the second region 52 on one circumferential side (+RD). Similarly, the end of the third region 53 on the radially outside (−RD) overlaps the end of the second region 52 on the other circumferential side (−RD).

In the resin portion 50 of the rotating electric machine 1 according to this embodiment, each orientation angle of the filler 50f in the first region 51, the second region 52, and the third region 53 is controlled. The orientation angle of the filler 50f in each region will be described in detail.

As shown in FIG. 4, the inclination angle of the longitudinal direction of the filler 50f with respect to the coil side surface 40a when viewed from the axial direction AD of the center axis J is defined as a first orientation angle α. In this embodiment, the number of the fillers 50f of which the first orientation angle α is less than 45° in the fillers 50f included in the first region 51 is preferably larger than the number of the fillers of which the first orientation angle α is 45° or more in the fillers 50f included in the first region 51. When the first orientation angle α of the filler 50f within the first region 51 is less than 45°, it becomes easier to arrange a wider area of the filler 50f closer to the coil side surface 40a. Particularly, as described in FIG. 4, when the filler 50f has a plate shape, the plate surface of the filler 50f is easily directed toward the coil side surface 40a. Therefore, since the heat of the coil 40 is easily transferred to the filler 50f, the coil 40 can be efficiently cooled.

Further, the fillers 50f of which the first orientation angle α is less than 45° in the first region 51 are easy to be arranged with the longitudinal direction of the filler 50f as the radial direction RD. According to this embodiment, the heat transferred from the coil 40 to the resin portion 50 in the first region 51 becomes easier to flow in the radial direction and becomes difficult to flow in the circumferential direction θ. That is, according to this embodiment, the thermal conductivity of the first region 51 in the radial direction RD is larger than the thermal conductivity in the circumferential direction θ. The core back portion 32 is disposed on the radially outside (−RD) of the first region 51. By increasing the thermal conductivity of the first region 51 in the radial direction RD, the heat received by the resin portion 50 from the coil 40 can be allowed to flow radially outward (−RD) and efficiently transmitted to the core back portion 32. Accordingly, it is possible to efficiently cool the coil 40 by moving the heat of the coil 40 to the core back portion 32.

Furthermore, in this embodiment, a case has been described in which 50% or more of the fillers 50f of the first region 51 have the first orientation angle α of less than 45°. However, in the fillers 50f of the first region 51, the fillers having the first orientation angle α of less than 45° is more preferably 60% or more and even more preferably 70% or more. In this way, it is possible to further improve the cooling efficiency of the coil 40 by increasing the ratio of the fillers 50f having the first orientation angle α of less than 45° included in the first region 51.

As described above, the first region 51 is a region along the coil side surface 40a and is a region separated from the coil side surface 40a by a certain distance. When the filler 50f described in FIG. 4 has a plate shape, the first region 51 is a region within three times the thickness t of the filler 50f from the coil side surface 40a in the resin portion 50 (d1≤3×t). In the following description, the thickness t of the filler 50f used as a reference for each dimension means the average value of the thickness of the filler 50f included in the resin portion 50. When the filler 50f has a plate shape, a region within three times the thickness t of the filler 50f is a region in which the filler 50f easily contacts the coil side surface 40a and easily receives heat directly from the coil side surface 40a. Therefore, the filler 50f actively receives heat from the coil 40 and can effectively improve the cooling performance of the coil 40 by setting the first region 51 in which the filler 50f having the first orientation angle α of less than 45° is dominant in the thickness range within three times the thickness t of the filler 50f. Further, when the filler 50f has a plate shape, it is easy to control the first orientation angle α of the filler 50f by introducing the uncured resin portion 50 into a narrow gap in the range approximately three times the thickness t of the filler 50f from the coil side surface 40a. According to this embodiment, it is easy to manufacture the resin portion 50 that improves the cooling performance of the coil 40.

Further, the first region 51 is preferably a region within 300 μm (d1≤300 μm) from the coil side surface 40a in the resin portion 50. The region within 300 μm from the coil side surface 40a is a region in which heat is easily transferred from the coil side surface 40a. Therefore, it is possible to effectively improve the cooling performance of the coil 40 by allowing the first region 51 in which the filler 50f having the first orientation angle α of less than 45° is dominant to have a thickness within 300 μm from the coil side surface 40a.

As shown in FIG. 4, the inclination angle of the longitudinal direction of the filler 50f with respect to the support surface 32a of the core back portion 32 when viewed from the axial direction AD of the center axis J is defined as a second orientation angle β. In this embodiment, the number of the fillers 50f of which the second orientation angle β is less than 45° in the fillers 50f included in the second region 52 is preferably larger than the number of the fillers 50f of which the second orientation angle β is 45° or more in the fillers 50f included in the second region 52. When the second orientation angle β of the filler 50f within the second region 52 is less than 45°, it becomes easier to arrange a wider area of the filler 50f closer to the support surface 32a. Therefore, since it is easy to transfer the heat transferred from the coil 40 to the resin portion from the resin portion 50 to the core back portion 32, it is easy to cool the coil 40.

Further, the fillers 50f of which the second orientation angle β is less than 45° in the second region 52 are easy to be arranged with the longitudinal direction of the filler 50f as the circumferential direction θ. According to this embodiment, the heat becomes easier to flow in the circumferential direction θ and becomes difficult to flow in the radial direction RD in the second region 52 along the support surface 32a. That is, according to this embodiment, the thermal conductivity of the circumferential direction θ of the second region 52 becomes larger than the thermal conductivity of the radial direction RD. Therefore, the heat can be dispersed in the circumferential direction of the resin portion 50 in the second region 52 and the heat of the resin portion 50 can be moved in the entire area of the circumferential direction of the core back portion 32 located on the radially outside (−RD) of the second region 52. According to this embodiment, since the heat of the coil 40 is easily moved to the core back portion 32 through the resin portion 50, it is possible to efficiently cool the coil 40.

Furthermore, in this embodiment, a case has been described in which 50% or more of the fillers 50f of the second region 52 have the second orientation angle β of less than 45°. However, in the fillers 50f of the second region 52, the fillers having the second orientation angle β of less than 45° are more preferably 60% or more and even more preferably 70% or more. In this way, it is possible to further improve the cooling efficiency of the coil 40 by increasing the ratio of the fillers 50f having the second orientation angle β of less than 45° included in the second region 52.

As described above, the second region 52 is a region along the support surface 32a and is a region separated from the support surface 32a by a certain distance. When the filler 50f described in FIG. 4 has a plate shape, the second region 52 is a region within three times the thickness t of the filler 50f from the support surface 32a in the resin portion 50 (d1≤3×t). When the filler 50f has a plate shape, the region within three times the thickness t of the filler 50f is a region in which the filler 50f easily contacts the support surface 32a and directly receives heat from the support surface 32a. Therefore, the filler 50f can actively deliver heat to the core back portion 32 by including the second region 52 in which the filler 50f having the second orientation angle β of less than 45° is dominant in such a thickness. Further, when the filler 50f has a plate shape, it is easy to control the second orientation angle β of the filler 50f in the range approximately three times the thickness t of the filler 50f from the support surface 32a. According to this embodiment, it is easy to manufacture the resin portion 50 that improves the cooling performance of the coil 40.

Further, the second region 52 is preferably a region within 300 μm (d1≤300 μm) from the support surface 32a in the resin portion 50. The region within 300 μm from the support surface 32a is a region in which heat is easily transferred from the support surface 32a. Therefore, it is possible to effectively improve the cooling performance of the coil 40 by allowing the second region 52 in which the filler 50f having the second orientation angle β of less than 45° is dominant to have a thickness within 300 μm from the support surface 32a.

As shown in FIG. 4, the inclination angle of the longitudinal direction of the filler 50f with respect to the protrusion side surface 33a when viewed from the axial direction AD of the center axis J is defined as a third orientation angle γ. In this embodiment, the number of the fillers 50f of which the third orientation angle γ is less than 45° in the fillers 50f included in the third region 53 is preferably larger than the number of the fillers 50f of which the third orientation angle γ is 45° or more in the fillers 50f included in the third region 53. When the third orientation angle γ of the filler 50f within the third region 53 is less than 45°, it becomes easier to arrange a wider area of the filler 50f closer to the protrusion side surface 33a. Therefore, since it is easy to transfer the heat transferred from the coil 40 to the resin portion from the resin portion 50 to the protrusion portion 33, it is easy to cool the coil 40.

Further, the fillers 50f of which the third orientation angle γ is less than 45° in the third region 53 are easy to be arranged with the longitudinal direction of the filler 50f as the radial direction RD. According to this embodiment, the heat becomes easier to flow in the radial direction RD and becomes difficult to flow in the circumferential direction θ in the third region 53 along the protrusion side surface 33a. That is, according to this embodiment, the thermal conductivity of the third region 53 in the radial direction RD is larger than the thermal conductivity in the circumferential direction θ. Therefore, the heat can be dispersed in the radial direction of the resin portion 50 in the third region 53 and the heat of the resin portion 50 can be moved in the entire area of the radial direction RD of the protrusion portion 33 adjacent to the third region 53. According to this embodiment, since the heat of the coil 40 is easily moved to the protrusion portion 33 through the resin portion 50, it is possible to efficiently cool the coil 40.

Furthermore, in this embodiment, a case has been described in which 50% or more of the fillers 50f of the third region 53 have the third orientation angle γ of less than 45°. However, in the fillers 50f of the third region 53, the fillers having the third orientation angle γ of less than 45° is more preferably 60% or more and even more preferably 70% or more. In this way, it is possible to further improve the cooling efficiency of the coil 40 by increasing the ratio of the fillers 50f having the third orientation angle γ of less than 45° included in the third region 53.

As described above, the third region 53 is a region along the protrusion side surface 33a and is a region separated from the protrusion side surface 33a by a certain distance. As in this embodiment, when the filler 50f has a plate shape, the third region 53 is a region within three times the thickness t of the filler 50f from the protrusion side surface 33a in the resin portion 50 (d1≤3×t). When the filler 50f has a plate shape, a region within three times the thickness t of the filler 50f is a region in which the filler 50f easily contacts the protrusion side surface 33a and easily receives heat from the protrusion side surface 33a. Therefore, the filler 50f can actively deliver heat to the protrusion portion 33 by including the third region 53 in which the filler 50f having the third orientation angle γ of less than 45° is dominant in such a thickness. Further, when the filler 50f has a plate shape, it is easy to control the third orientation angle γ of the filler 50f in the range approximately three times the thickness t of the filler 50f from the protrusion side surface 33a. According to this embodiment, it is easy to manufacture the resin portion 50 that improves the cooling performance of the coil 40.

Further, the third region 53 is preferably a region within 300 μm (d1≤300 μm) from the protrusion side surface 33a in the resin portion 50. The region within 300 μm from the protrusion side surface 33a is a region in which heat is easily transferred from the protrusion side surface 33a. Therefore, it is possible to effectively improve the cooling performance of the coil 40 by allowing the third region 53 in which the filler 50f having the third orientation angle γ of less than 45° is dominant to have a thickness within 300 μm from the protrusion side surface 33a.

In this embodiment, each of the first orientation angle «, the second orientation angle β, and the third orientation angle γ is an angle defined when viewed from the axial direction. Thus, the first orientation angle «, the second orientation angle β, and the third orientation angle γ can be specified by cutting the stator 30 along a plane orthogonal to the axial direction and observing the posture of the filler 50f in the resin portion 50.

FIG. 6 is an example of a flowchart of a method of manufacturing the stator 30 of the rotating electric machine 1 according to this embodiment. The method of manufacturing the stator 30 of the rotating electric machine 1 according to this embodiment includes, for example, a resin application step S10, a coil attachment step S20, a resin curing step S30, a jig removal step S40, and a resin addition step S50. The resin application step S10, the coil attachment step S20, the resin curing step S30, the jig removal step S40, and the resin addition step S50 are performed in this order. Further, the jig removal step S40 may be performed before the resin curing step S30. Furthermore, the method of manufacturing the stator 30 described here is merely an example and the stator 30 may be manufactured according to a different manufacturing method. Further, in the method of manufacturing the stator 30 described here, a part of steps may be changed or deleted. For example, the resin addition step S50 may not be performed.

In the method of manufacturing the stator 30 of the rotating electric machine 1 according to this embodiment, the stator core 31 and the coil 40 are prepared in advance. The stator core 31 is formed, for example, by laminating a plurality of steel plates formed by press punching or wire electric discharge machining in the thickness direction. Further, the coil 40 is formed by winding the coil wire 42e in a coil shape.

The resin application step S10 is a step of applying the uncured resin portion 50 to the inner periphery of the stator core 31. The filler 50f is included in the uncured resin portion 50 in advance. Therefore, the uncured resin portion 50 has sufficient viscosity to be held on the surface of the stator core 31. The resin portion 50 is applied onto the support surface 32a of the core back portion 32 and the protrusion side surface 33a of the protrusion portion 33.

The coil attachment step S20 is a step of attaching the coil 40 to the stator core 31. As shown in FIG. 3, the coil 40 is disposed between the protrusion portions 33 arranged in the circumferential direction in the coil attachment step S20. Further, in the coil attachment step S20, the coil 40 is pressed against the support surface 32a of the core back portion 32.

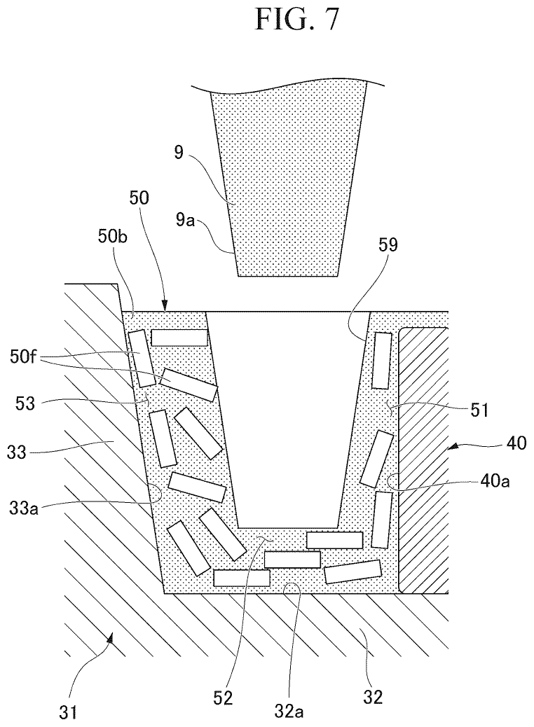

The coil attachment step S20 is performed by, for example, a jig 9 (see FIG. 7) which holds the coil 40. The jig 9 holds the coil side surfaces 40a of the coil 40 on both circumferential sides by a pair of claw portions 9a. Further, the jig 9 applies a pressure radially inward (+RD) to the coil 40 at the pressurizing portion to press the coil 40 against the support surface 32a.

The resin curing step S30 is a step of curing the adhesive 50b included in the uncured resin portion 50. When the adhesive 50b includes a thermosetting resin, the resin curing step S30 is a step of applying heat to the resin portion 50. When the adhesive 50b includes an ultraviolet curable resin, the resin curing step S30 is a step of irradiating the resin portion 50 with ultraviolet rays. When the adhesive 50b is naturally cured, the resin curing step S30 is a step of waiting for a predetermined time. The resin curing step S30 can be performed at an atmospheric pressure, but may also be performed under a decreased pressure or under an increased pressure. Further, these increased and decreased pressures may be combined. By appropriately controlling the pressure for performing the resin curing step S30, air bubbles can be effectively removed, pores formed in the resin portion 50 can be suppressed, and excellent mechanical strength and heat conductivity can be obtained.

It is preferable that the pressurization by the jig 9 is continued until the resin curing step S30 is completed. The retention of the coil 40 by the claw portions 9a of the jig 9 may be released when performing the resin curing step S30. The claw portions 9a are continuously arranged between the coil side surface 40a and the protrusion side surface 33a until the resin curing step S30 is completed. In the resin curing step S30, there is a space between the claw portion 9a and the coil side surface 40a that does not make direct contact. Similarly, in the resin curing step S30, there is a space between the claw portion 9a and the protrusion side surface 33a that does not make direct contact. In the resin curing step S30, a part of the resin portion 50 flows between the claw portion 9a and the coil side surface 40a and between the claw portion 9a and the protrusion side surface 33a to be cured therein before the resin portion 50 is cured. The filler 50f in the resin portion 50 flows into the narrow gap and is oriented in the direction in which the gap extends. Due to this action, the filler 50f in the resin portion 50 is arranged along each side of the gap into which the resin portion 50 is introduced. As a result, the first orientation angle α, the second orientation angle β, and the third orientation angle γ of the resin portion 50 decrease. According to the method of manufacturing the stator 30 of the rotating electric machine 1 according to this embodiment, the orientation angle of the filler 50f can be controlled in this way. Further, the orientation angle of the filler 50f is fixed by curing the adhesive 50b of the resin portion 50 while continuing this state. In the manufacturing method described here, the length of the filler 50f in the longitudinal direction is preferably larger than the thickness t of the filler 50f and preferably 1 μm or more and 10 mm or less. Accordingly, the controllability of the filler orientation angle can be improved.

FIG. 7 is a schematic view showing the jig removal step S40. The jig removal step S40 is a step of separating the jig 9 from the cured resin portion 50. In order to smoothly perform the jig removal step S40, it is preferable that the surface of the claw portion 9a of the jig 9 is subjected to some kind of surface treatment to promote mold release. A concave portion 59 is formed in a portion in which the claw portion 9a is disposed in the cured resin portion 50 through the jig removal step S40. The concave portion 59 opens radially outward.

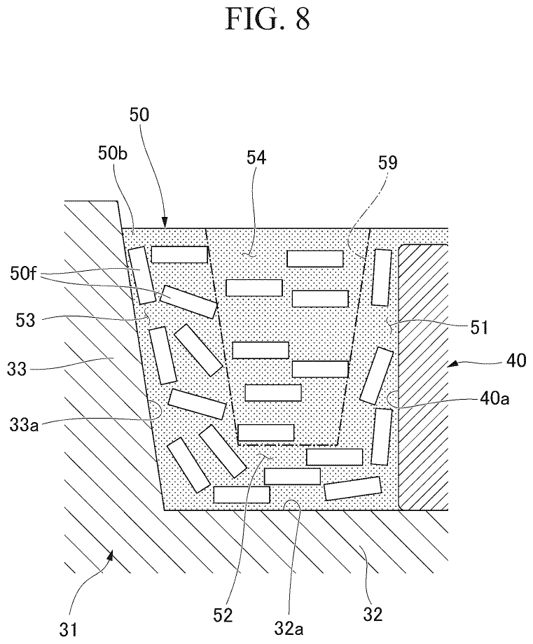

FIG. 8 is a schematic view showing the resin addition step S50. The resin addition step S50 is a step of filling an additional resin portion 50 into the concave portion 59 formed in the jig removal step S40. The additional resin portion 50 corresponds to the fourth region 54 shown in FIG. 3. In this embodiment, the resin portion 50 of the fourth region 54 filled in the concave portion 59 consists of the filler 50f and the adhesive 50b which are the same as those of the resin portion 50 of the other regions (the first region 51, the second region 52, and the third region 53). Further, the resin portion 50 of the fourth region 54 may have a configuration different from the other regions. As an example, the resin portion 50 of the fourth region 54 may not include the filler 50f, and the filler included therein may be a different filler from other regions, such as a spherical filler. Further, different adhesives 50b may be used. The resin portion 50 filled in the concave portion 59 by the resin addition step S50 is cured by a separate resin curing step. Through the above-described steps, the stator 30 of the rotating electric machine 1 according to this embodiment can be manufactured.

Furthermore, in the method of manufacturing the rotating electric machine 1 of this embodiment, a case has been described in which a sufficiently wide gap for disposing the claw portion 9a of the jig 9 is formed between the coil 40 and the protrusion portion 33. However, when the gap between the coil 40 and the protrusion portion 33 is narrow, the claw portion 9a may not be disposed in this gap.

Further, in the rotating electric machine 1 of this embodiment, a case has been described in which the stator core 31 includes the protrusion portion 33, but the stator core 31 does not include the protrusion portion 33.

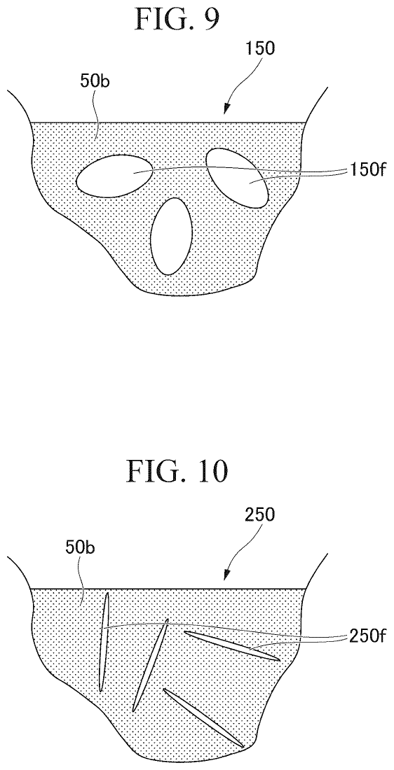

FIG. 9 is a schematic view of a resin portion 150 of a first modified example which can be adopted in the rotating electric machine 1 according to the above-described embodiment. FIG. 9 is an enlarged view of a region IV shown in FIG. 3 in the first modified example. As shown in FIG. 9, the resin portion 150 may have an ellipsoidal filler 150f. Here, the ellipsoidal shape includes not only elliptical spherical shapes in the strict sense but also those with shapes that can be considered elliptical spherical shapes.

FIG. 10 is a schematic view of a resin portion 250 of a second modified example which can be adopted in the rotating electric machine 1 according to the above-described embodiment. FIG. 10 is an enlarged view of a region IV shown in FIG. 3 in the second modified example. As shown in FIG. 10, the resin portion 250 may include a needle-shaped filler 250f.

According to at least one of the above-described embodiments, since the resin portion 50 capable of increasing the thermal conductivity of the radial direction RD of the first region 51 along the coil side surface 40a is provided, it is possible to provide the rotating electric machine 1 capable of efficiently transferring the heat of the coil 40 to the stator core 31.

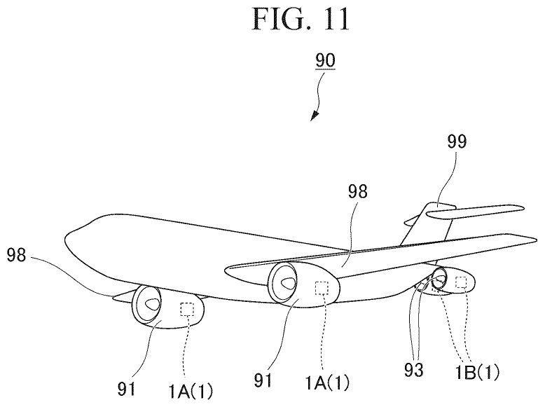

The above-described rotating electric machine can be mounted on various driving objects such as automobiles, railways, and aircraft. FIG. 11 is a schematic view of the aircraft 90 as an example of a driving object on which the rotating electric machine 1 is mounted. The aircraft 90 is a hybrid aircraft that is propelled by a combination of the jet engine 91 and the rotating electric machine 1. The aircraft 90 includes the pair of jet engines 91 and four rotating electric machines 1. The jet engine 91 is provided in a main wing 98. The jet engine 91 generates thrust by exhausting the air backward.

Four rotating electric machines 1 are classified into two power generating rotating electric machines 1A and two driving rotating electric machines 1B. Each power generating rotating electric machine 1A is connected to a main shaft of the jet engine 91. The power generating rotating electric machine 1A generates power by the jet engine 91. On the other hand, the driving rotating electric machine 1B is disposed below a vertical tail 99. The driving rotating electric machine 1B sends air backward and generates thrust by rotating the propulsion fan 93. The driving rotating electric machine 1B is driven by the power generated by the power generating rotating electric machine 1A. Furthermore, when the power generating rotating electric machine 1A generates surplus power, this power may be charged into a battery and used when necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rotating electric machine comprising:
a stator which has an annular shape centered on a center axis; and
a rotor which is located on one radial side of the stator, the rotor being supported to be rotatable around the center axis,
wherein the stator comprises:
a stator core which includes a core back portion having an annular shape centered on the center axis;
a coil comprising a bundle of coil wires, the coil being disposed on one radial side of the core back portion; and
a resin portion which fixes the coil to the stator core,
wherein the resin portion comprises:
a first region which extends in a radial direction along a coil side surface facing a circumferential direction of the coil; and
a second region which extends in the circumferential direction along a support surface facing the one radial side of the core back portion,
wherein the resin portion includes fillers, and
wherein the first region has a first thermal conductivity in the radial direction and a second thermal conductivity in the circumferential direction, and the first thermal conductivity is greater than the second thermal conductivity.

2. The rotating electric machine according to claim 1
wherein the second region has a third thermal conductivity in the circumferential direction and a fourth thermal conductivity in the radial direction, and the third thermal conductivity is greater than the fourth thermal conductivity.

3. The rotating electric machine according to claim 1,
wherein the stator core includes a protrusion portion which protrudes from the core back portion toward the one radial side of the core back portion and faces the coil in the circumferential direction,
wherein the resin portion includes a third region which extends in the radial direction along a protrusion side surface facing the circumferential direction of the protrusion portion, and
wherein the thermal conductivity of the third region in the radial direction is larger than the thermal conductivity thereof in the circumferential direction.

4. A rotating electric machine comprising:
a stator which has an annular shape centered on a center axis; and
a rotor which is located on one radial side of the stator, the rotor being supported to be rotatable around the center axis,
wherein the stator comprises:
a stator core which includes a core back portion having an annular shape centered on the center axis;
a coil comprising a bundle of coil wires, the coil being disposed on one radial side of the core back portion; and
a resin portion which fixes the coil to the stator core,
wherein the resin portion comprises:
a first region which extends in the radial direction along a coil side surface facing the circumferential direction of the coil; and
a second region which extends in the circumferential direction along a support surface facing the one radial side of the core back portion,
wherein the resin portion includes fillers, each filler has a respective longitudinal direction having a first orientation angle which is defined to be a first inclination angle inclined with respect to the coil side surface in view of an axial direction of the center axis,
wherein the fillers in the first region comprises a first group of fillers which are smaller in the first orientation angles than 45°, and a second group of fillers which are equal or greater in the first orientation angles than 45°, and the number of the first group of fillers is greater than the number of the second group of fillers.

5. The rotating electric machine according to claim 4,
wherein the fillers are plate-shaped, and
wherein the first region is defined to be a region within three times the thickness of the filler from the coil side surface in the resin portion.

6. The rotating electric machine according to claim 4,
wherein the first region is defined to be a region within 300 μm from the coil side surface in the resin portion.

7. The rotating electric machine according to claim 4,
wherein the respective longitudinal direction of each filler has a second orientation angle which is defined to be a second inclination angle inclined with respect to the support surface in view of an axial direction of the center axis,
wherein the fillers in the second region comprises a third group of fillers which are smaller in the second orientation angles than 45°, and a fourth group of fillers which are equal or greater in the second orientation angles than 45°, and the number of the third group of fillers is greater than the number of the fourth group of fillers.

8. The rotating electric machine according to claim 7,
wherein the fillers are plate-shaped, and
wherein the second region is defined to be a region within three times the thickness of the filler from the support surface in the resin portion.

9. The rotating electric machine according to claim 7,
wherein the second region is defined to be a region within 300 μm from the support surface in the resin portion.

10. The rotating electric machine according to claim 4,
wherein the stator core includes a protrusion portion which protrudes from the core back portion toward one radial side of the core back portion and faces the coil in the circumferential direction,
wherein the resin portion includes a third region which extends in the radial direction along a protrusion side surface facing the circumferential direction of the protrusion portion,
wherein the respective longitudinal direction of each filler has a third orientation angle which is defined to be a third inclination angle inclined with respect to the protrusion side surface facing the circumferential direction of the protrusion portion,
wherein the fillers in the third region comprises a fifth group of fillers which are smaller in the third orientation angles than 45°, and a sixth group of fillers which are equal or greater in the third orientation angles than 45°, and the number of the fifth group of fillers is greater than the number of the sixth group of fillers.

11. The rotating electric machine according to claim 10,
wherein the fillers are plate-shaped
wherein the third region is defined to be a region within three times the thickness of the filler from the protrusion side surface in the resin portion.

12. The rotating electric machine according to claim 10,
wherein the third region is defined to be a region within 300 μm from the protrusion side surface in the resin portion.

13. The rotating electric machine according to claim 4,
wherein the fillers are ellipsoidal-shaped.

14. The rotating electric machine according to claim 4,
wherein the fillers are needle-shaped.
